(19) United States
(12) Patent Application Publication
(10) Pub. No.: US 2006/0236795 A1
(43) Pub. Date: Oct. 26, 2006

(54) Toroidal regulating device

(75) Inventor: Steffen Henzler, Bobingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 10/541,867

(22) PCT Filed: Dec. 18, 2003
(86) PCT No.: PCT/EP03/14500

§ 371 Date: Jun. 5, 2006

(30) Foreign Application Priority Data
Jan. 10, 2003 (DE) 103 00 569.2

(51) Int. Cl. F16H 21/32

(52) U.S. Cl. 74/40

(57) ABSTRACT

A toroidal regulating device for regulating the torque of a motor vehicle toroidal variator has at least one regulator and a first regulating variable which can be fed back to the regulator. The formation of includes at least one first characteristic quantity for a transmitted torque in the toroidal variator. At least one second regulating variable is capable of being fed back. The formation of the second variable includes at least one second characteristic quantity for a pivoting speed of an intermediate roller of the toroidal variator.

### BACKGROUND OF THE INVENTION

The present invention relates particularly to a toroidal regulating device, and more particularly to a device for regulating the torque of a toroidal variator, in particular of a motor vehicle, with at least one regulator and with a first regulating variable which can be fed back to the regulator and the formation of which includes at least one first characteristic quantity for a transmitted torque in the toroidal variator.

“Society of Automotive Engineers, Inc., 2002-01-0586, Full Toroidal IVT Variator Dynamics”, Robert D. Fuchs and Yasuhiko Hasuda, in particular page 3, column 2, FIG. 6, discloses a generic toroidal regulating device for regulating the torque of a toroidal variator of a motor vehicle, with a regulator. A regulating variable formed by a characteristic quantity for a transmitted torque in the toroidal variator can be fed back to the regulator. The determination of the characteristic quantity forming the regulating variable includes a characteristic quantity of a pressure in a piston/cylinder unit of the toroidal variator.

An object of the present invention is to provide a toroidal regulating device which, at a generally low outlay in structural terms, allows a particularly stable regulating behavior with a short adjusting time and which, furthermore, is suitable particularly for transmissions with a geared-neutral function.

The present invention is implemented in a toroidal regulating device for regulating the torque of a toroidal variator, in particular of a motor vehicle, by providing at least one regulator and with a first regulating variable which can be fed back to the regulator and the formation of which includes at least one first characteristic quantity for a transmitted torque in the toroidal variator.

The present invention is based on the recognition that, in transmissions with a geared-neutral function, standstill can be brought about only when the step-up is discrete. In the case of stepup-regulated toroidal variators or with a toroidal regulating device for stepup regulation, the discrete stepup can be set only at high outlay. With torque-regulated toroidal variators or with toroidal regulating devices for torque regulation, however, standstill in the case of transmissions with a geared-neutral function can be implemented in a simple way in regulating terms, and therefore toroidal regulating devices for torque regulation are suitable particularly for transmissions with a geared-neutral function. Moreover, as compared with toroidal regulating devices for ratio regulation, toroidal regulating devices for torque regulation allow a particularly simple and exact variation of the torque, with the result that these are also particularly suitable for transmissions having different driving ranges.

By the toroidal regulating device being configured according to the invention with at least one second feedback regulating variable, the formation of which includes at least one second characteristic quantity for a pivoting speed of an intermediate roller of the toroidal variator, advantageous damping and consequently a stable system can be achieved at least largely without a technically implemented castor angle. The center angle is to be understood as meaning an angle between an intermediate roller mounting or an actuating piston of an intermediate roller and the perpendicular to the central shafts of the toroidal variator. If the castor angle can be reduced, in particular smaller than 5°, and particularly advantageously can be set equal to zero or an actuating piston of the intermediate roller can be arranged perpendicularly to central shafts of the toroidal variator, then, in particular, the outlay in structural terms, i.e., the weight, components and construction space can be saved. In the case of a zero castor angle, no pivoting of the intermediate roller can be achieved only in one position, as compared with a castor angle unequal to zero. Consequently, a small stroke of the actuating piston can be achieved and energy can be saved. Furthermore, high flexibility, particularly in terms of structural refinements, can be achieved in a simple way by a variability of individual parameters.

If the determination of the second characteristic quantity includes at least one characteristic quantity for a rotational speed at the input of the toroidal variator and at least one characteristic quantity for a rotational speed at the output of the toroidal variator, then advantageously sensors usually already present can be utilized and additional sensors can be avoided. A stepup in rotational speed of the toroidal variator can be deduced from a quotient of the characteristic quantity of the rotational speed at the input of the toroidal variator and of the characteristic quantity of the rotational speed at the output of the toroidal variator. This quantity can then either be differentiated directly or, in an intermediate step, first be converted into a corresponding pivot angle and subsequently be differentiated. The characteristic quantities for the rotational speeds can either be detected directly on the toroidal variator via sensors or rotational speed values can be used which have been determined elsewhere and make it possible to determine the rotational speed at the input and at the output of the toroidal variator.

Additionally or alternatively, in order to determine the second characteristic quantity, other quantities which seem to be appropriate to a person skilled in the art could also be detected, such as, for example, directly, an existing pivot angle via which a pivoting speed can be deduced by differentiation.

In a further refinement of the invention, the second regulating variable can be the result of a multiplication by at least one proportionality factor. Via the proportionality factor, a desired damping can be set in a controlled manner, for example, advantageously, a damping of one, and the system can be optimized in a simple way. If the proportionality factor is dependent on at least one operating variable, such as on an existing rotational speed, load and/or temperature, etc., in that, for example, this is read out from a corresponding characteristic map during a regulating process or is determined via a corresponding analytical function, constant damping can be achieved independently of various operating situations and/or damping can advantageously be adapted to various operating situations.

Furthermore, the second regulating variable can be fed to a manipulated variable of the regulator, this having an advantageous effect on the regulating behavior. In principle, however, the second regulating variable could also be capable of being fed to a command variable.

If the determination of the first characteristic quantity includes at least one characteristic quantity for a pressure in a piston/cylinder unit of the toroidal variator, then cost-effective sensor technology can also be achieved. For this purpose, either two absolute pressure sensors, i.e., measurement with respect to a vacuum, or two relative pressure sensors, i.e., measurement with respect to an ambient pressure and/or a differential pressure sensor may be employed.

Alternatively, even only one of the two first-mentioned sensors may be used if an already known pressure, for example ambient pressure or system pressure, always prevails in one of two chambers of a cylinder for supporting the intermediate roller. The sensor would in this case advantageously be connected selectively, for example via a changeover valve, to that chamber in which the unknown pressure prevails.

Instead of detecting the pressures via a sensor, these measures could also be routed hydraulically in each case to a regulating slide or to a regulating slide valve, with the result that an advantageously low outlay in manufacturing terms and high operating reliability can be achieved. If in this case at least one of the regulating slides has exactly two control edges, the outlay in manufacturing terms can be further reduced and the manufacturing costs can be lowered as a result of the reduced tolerance requirements. In this connection reference is made to unpublished application DE 102 33 089.

Additionally or alternatively, however, a torque at the input of the toroidal variator, a torque at the output of the toroidal variator and/or a supporting force on the intermediate roller could also be detected, for example, by way of force measurement between a holding arm of the intermediate roller and an actuating piston.

The regulator may be configured with various regulating elements which seem appropriate to a person skilled in the art. If, however, the regulator is a PID regulator or is provided at least with an integral element and a differential element, stationary regulating deviations can advantageously be avoided by the integral element and an overshoot can advantageously be avoided by the differential element.

The solution according to the present invention is suitable, in principle, for all types of toroidal variators, but, in addition to half toroidal variators, particularly advantageously for full toroidal variators in which a castor angle is used in a known way for achieving damping.

Other objects, advantages and novel features of the present invention will become apparent from the following detailed description of the invention when considered in conjunction with the accompanying drawings.

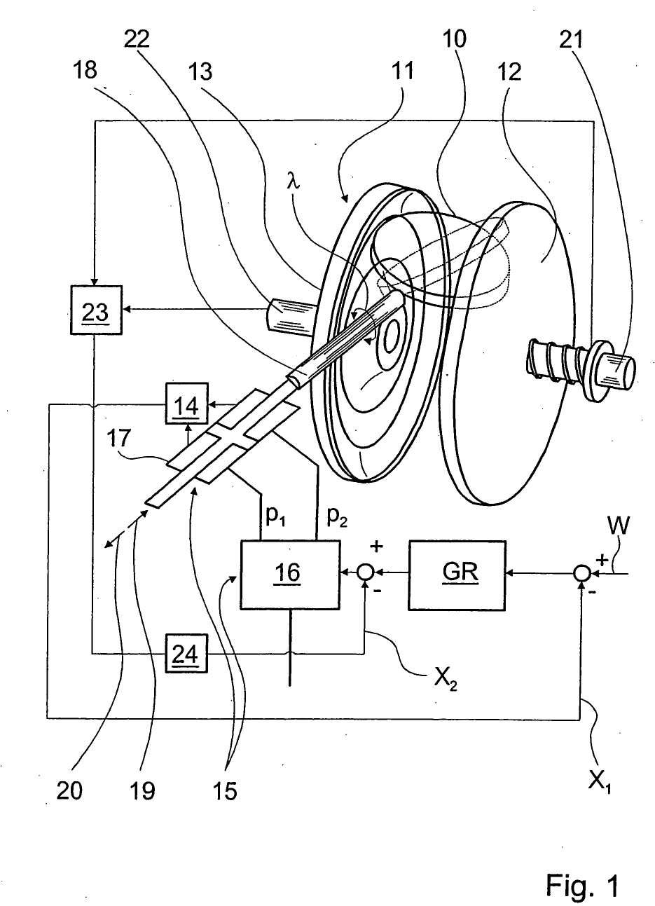

FIG. 1 is a schematic, partially perspective view of a full toroidal transmission with a toroidal regulating device according to the present invention, and

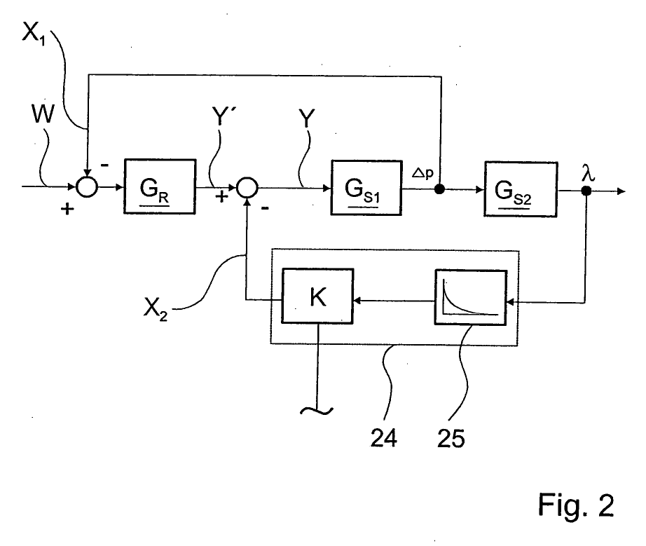

FIG. 2 is a block diagram of the toroidal regulating device shown in FIG. 1.

### DETAILED DESCRIPTION OF THE DRAWINGS

FIG. 1 shows a detail of a diagrammatically illustrated full toroidal transmission of a motor vehicle, with a toroidal regulating device for regulating the torque of a toroidal variator designated generally by numeral 11. The toroidal variator 11 comprises an intermediate roller 10 which is arranged between two toroidal disks 12, 13 and of which the pivot angle λ between the toroidal disks 12, 13 can be set via a hydraulic actuating unit designated generally by numeral 15. For this purpose, the actuating unit 15 has a valve block 16, via which a pressure difference p1−p2 can be set in a double-acting piston/cylinder unit 17. The piston/cylinder unit 17 is connected to the intermediate roller 10 via a piston rod 18 which is displaceable in the direction of double arrows 19, 20 via an actuating force of the piston/cylinder unit 17 the pivot angle λ thereby being capable of being set. The piston rod 18 is oriented perpendicularly to central shafts 21, 22 of the toroidal variator 11. The full toroidal transmission possesses a castor angle equal to zero.

According to the invention, the toroidal regulating device has a regulator G_{R} designed as a PID regulator. A first regulating variable X₁ can be fed back to the regulator. The formation of which first regulating variable X₁ includes a first characteristic quantity for the transmitted torque in the toroidal variator 11 (FIG. 2). For this purpose, a differential pressure in the piston/cylinder unit 17 or after a first controlled system part G_{S1} can be detected via a sensor unit 14 having a differential pressure sensor, a command variable W with a desired pressure sequence being fed, during operation, to the regulator G_{R} in addition to the first regulating variable X₁.

In addition to the first regulating variable X₁, a second regulating variable X₂ can be fed back. The formation of the variable X₂ includes a second characteristic quantity for a pivoting speed of the intermediate roller 10 of the toroidal variator 11. The determination of the second characteristic quantity includes a characteristic quantity for the rotational speed at the input of the toroidal variator 11 or an input rotational speed of the toroidal variator 11 and a characteristic quantity for a rotational speed at the output of the toroidal variator 11 or an output rotational speed of the toroidal variator 11. The input rotational speed and the output rotational speed can be detected via a sensor unit 23 after a second controlled system part G_{S2} (FIG. 2). A quotient of the detected rotational speeds or a rotational speed stepup is determined via an evaluation unit 24. From the rotational speed stepup, a pivot angle is determined which is subsequently differentiated in a differential element 25. A pivoting speed determined therefrom is then multiplied, during operation, by a proportionality factor K which is dependent on a detected transmission oil temperature and an existing load and is dependent on the input rotational speed of the toroidal variator 11. For this purpose, the proportionality factor K is read out from a known type of characteristic map filed in a memory, (not illustrated).

The second regulating variable X₂ formed from the result of the multiplication is added, during the regulating process, to an auxiliary manipulated variable Y′ of the regulator. The result of the addition forms a main manipulated variable Y fed to the valve block 16.

1-10. (canceled)

11. A toroidal regulating device for regulating the torque of a toroidal variator, comprising at least one regulator a first regulating variable be fed back to the regulator and the formation of which includes at least one first characteristic quantity for a transmitted torque in the toroidal variator, and at least one second regulating variable (X₂) which can be fed back, and the formation of which includes at least one second characteristic quantity for a pivoting speed of an intermediate roller of the toroidal variator.

12. The toroidal regulating device as claimed in claim 11, wherein the second characteristic quantity is determined to include at least one characteristic quantity for a rotational speed at the input of the toroidal variator (11) and at least one characteristic quantity for a rotational speed at the output of the toroidal variator.

13. The toroidal regulating device as claimed in claim 11, wherein the second regulating variable comprises the result of a multiplication by at least one proportionality factor (K).

14. The toroidal regulating device as claimed in claim 13, wherein the proportionality factor is dependent on at least one operating variable.

15. The toroidal regulating device as claimed in claim 11, wherein the device is configured such that the second regulating variable can be fed to a manipulated variable (Y′) of the at least one regulator.

16. The toroidal regulating device as claimed in claim 11, wherein the first characteristic quantity is determined to include at least one characteristic quantity for a pressure in a piston/cylinder unit of the toroidal variator.

17. The toroidal regulating device as claimed in claim 11, wherein the at least one regulator is designed as a PID regulator.

18. A method with a toroidal regulating device as claimed in claim 11, comprising forming a first regulating variable which includes at least one first characteristic quantity for a transmitted torque in the toroidal variator, feeding back the first regulating variable to the at least one regulate, forming at least one second regulating variable which includes at least one second characteristic quantity for a pivoting speed of an intermediate roller (10) of the toroidal variator (11), and feeding back to at least one second regulating variable to the at least one regulator.

19. The method as claimed in claim 18, the at least one second regulating variable is fed to a manipulated variable of the regulator (G_{R}).

20. A toroidal transmission with a toroidal regulating device as claimed in claim 11, further comprising a castor angle smaller than 5°.
